(19) United States
(12) Patent Application Publication
(10) Pub. No.: US 2011/0054768 A1
(43) Pub. Date: Mar. 3, 2011

(54) SYSTEMS AND METHODS FOR OPTIMIZING VEHICLE FUEL EFFICIENCY

(76) Inventor: Joshua Ward SULLIVAN, Rochester, NY (US)

(21) Appl. No.: 12/606,637

(22) Filed: Oct. 27, 2009

Related U.S. Application Data
(60) Provisional application No. 61/237,340, filed on Aug. 27, 2009.

(51) Int. Cl. G06F 19/00; F02D 43/00

(52) U.S. Cl. 701/123

(57) ABSTRACT

A method for optimizing the fuel efficiency of a motor vehicle includes electronically receiving data on an ambient environment of a motor vehicle. The data is electronically compared to a current operational status of the vehicle. The current operational status is automatically adjusted based on the comparing to optimize the fuel efficiency of the motor vehicle.

### CROSS-REFERENCE TO RELATED APPLICATIONS

This application claims priority under 35 U.S.C.§119 to U.S. Provisional Application No. 61/237,340, filed Aug. 27, 2009, entitled System For Optimizing Fuel Efficiency In A Motor Vehicle, which is herein incorporated by reference in its entirety.

### BACKGROUND OF THE INVENTION

Many strategies have been proposed to address our society's dependence on fossil fuels by increasing vehicle fuel efficiency. For example, efforts to increase fuel efficiency from drivers have included modifying their driving habits and inputs to the vehicles by eco-driving or “hypermiling”. These techniques are employed by drivers to optimize fuel efficiency and include gliding, coasting, turning off the engine at stop lights and a host of other strategies. Estimates from automotive industry organizations indicate that effective hypermiling can increase fuel efficiency by 30%. Currently, drivers have to use their personal judgment and guess when it is the appropriate time and manner in which to employ hypermiling strategies.

Current hypermiling devices only incorporate diagnostic data from a vehicle's on-board computer diagnostic tabulator and passively alert the driver as to the efficiency of past driving but do nothing to predict or prepare a driver for upcoming obstacles or driving conditions. In many new cars today past MPG is used to predict how many more miles the current fuel in the gas tank will go. However, these predictions are based on past driving habits and current acceleration, and further, they are purely for information purposes only.

Some products currently on the market are described below.

SCANGAUGE is a device that plugs into the OBDII port and gives real time feed back on engine performance. This basic feed back is not instructive and will only display the user's current mpg and other real time data.

GREENROAD is a program that insurance carriers are pushing to rate drivers risk behaviors. The program rates a driver on specific techniques and claims fuel efficiencies as a secondary outcome. The efficiencies gained by using the product are an effect of drivers observing less risky behaviors and as a secondary benefit but not the focus.

The KIWI is sold as a hardware piece that connects to the OBDII port and is a dash mounted piece that displays fuel efficiency outputs such as acceleration, as well as providing a “Kiwi” score to rate users green driving. The product boasts an improvement of 20-33% gain in mpg. However, the device only records past driving habits.

DYNOLICIOUS is an IPHONE application utilizing the IPHONE's accelerometer to give driving enthusiasts information about 0-60 times and performance statistics. However, it does not connect to the OBDII port and is focused on racing statistics.

In another example, Nissan has developed a mechanism that attempts to moderate acceleration by pushing back on the gas peddle if a driver is accelerating beyond a pre-determined mpg.

Thus, a need exists for systems and methods for proactively controlling an engine or providing drivers inputs to achieve optimal fuel efficiency using location based information.

### SUMMARY OF THE INVENTION

The present invention provides, in a first aspect, a method for optimizing the fuel efficiency of a motor vehicle which includes electronically receiving data on an ambient environment of a motor vehicle. The data is electronically compared to a current operational status of the vehicle. The current operational status is automatically adjusted based on the comparing to optimize the fuel efficiency of the motor vehicle.

The present invention provides, in a second aspect, a system for optimizing the fuel efficiency of a motor vehicle which includes means for electronically retrieving data on an ambient environment of a motor vehicle, means for electronically comparing the data to a current operational status of the vehicle, and means for automatically adjusting the current operational status based on the comparing to optimize the fuel efficiency of the motor vehicle.

The present invention provides, in a third aspect, a method for optimizing the fuel efficiency of a motor vehicle which includes electronically retrieving data on an ambient environment and a projected path of a motor vehicle. The data is electronically compared to current operational status of the vehicle. Suggested adjustment criteria is output to a user based on the comparing to allow the user to provide input to control systems of the motor vehicle to optimize the fuel efficiency of the motor vehicle.

The present invention provides, in a further aspect, a controller configured to electronically retrieve data on an ambient environment of a motor vehicle. The controller is configured to electronically compare the data to a current operational status of the vehicle. The controller is configured to automatically adjust the current operational status based on the comparing to optimize the fuel efficiency of the motor vehicle.

The present invention provides, in yet a further aspect, at least one program storage device readable by a machine, tangibly embodying at least one program of instruction executable by a machine to perform a method for optimizing the fuel efficiency of a motor vehicle which includes electronically retrieving data on an ambient environment of a motor vehicle. The method further includes comparing the data to current operational status of the vehicle and automatically adjusting the current operational status based on the comparing to optimize the fuel efficiency of the motor vehicle.

### BRIEF DESCRIPTION OF THE DRAWINGS

FIG. 1 is a block diagram of a system for optimizing fuel efficiency in accordance with the present invention; and

FIG. 2 is a flow chart diagram of a method for optimizing fuel efficiency in accordance with the present invention.

### DETAILED DESCRIPTION OF THE INVENTION

In accordance with the principles of the present invention, systems and methods for optimizing a fuel efficiency of a motor vehicle are provided.

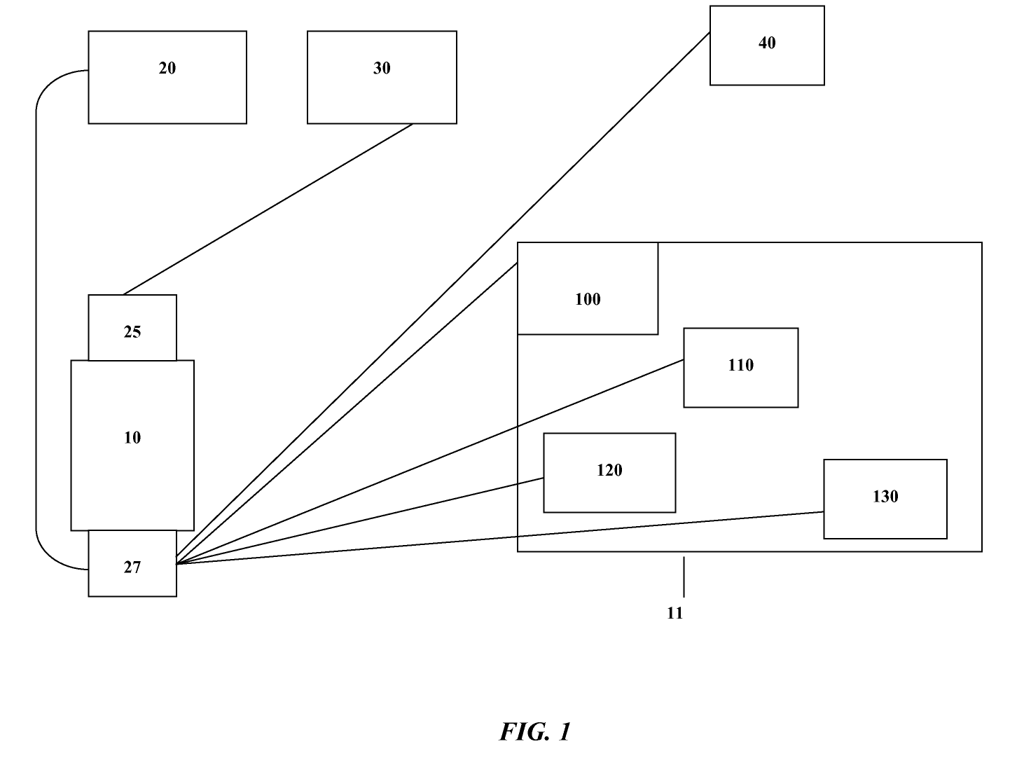

In an exemplary embodiment depicted in FIG. 1, a system 5, or means, for optimizing a fuel efficiency of a motor vehicle (e.g., a passenger car, truck, bus, train, etc.) includes a controller 10 coupled to one or more sources of information about the ambient environment nearby the vehicle or on a projected path of the motor vehicle and one or more system(s) 11 of a motor vehicle.

In one embodiment depicted in FIG. 1, controller 10 is coupled to a computer server remote from the motor vehicle, such as a computing unit 20, which may store geographic information, such as topographic information. Controller 10 may include, or be connected to, an antenna 27 for sending and receiving data over a cellular, WI-FI, or other wireless network to allow communication between controller 10 and various sensors and/or other sources of data (e.g., topographic information from server 20). Further, controller 10 may be coupled via such a wireless network or via a standard wired network to various control mechanisms and systems 11 of the motor vehicle. Such systems may include an engine 100, a braking system 110, accelerator system 120, a diagnostic computer 130, or any other system for controlling and/or monitoring the motor vehicle. Such systems may be those of a standard gasoline engine, diesel engine, hybrid-electric engine, plug-in hybrid engine, or any other means of propelling such a motor vehicle. The systems of the motor vehicle to be controlled by controller 10 may be user-controlled systems, such as braking, acceleration, and tire inflation, or may be non-user-controlled systems, such as transmission systems, engine control systems (e.g., sparkplug timing, piston activation), and systems for controlling when to engage a gasoline versus an electric propulsion system to optimize fuel efficiency.

Also, controller 10 may be coupled to a GPS receiver 25 for receiving signals from a global positioning system (GPS) 30 to provide location information relative to controller 10 and the vehicle into which it is located or mounted. Any GPS information received by controller 10 may be matched with corresponding data received from other sources, such as topographic information from computing unit 20, such that controller 10 may map the topographic landscape around the motor vehicle and the landscape of the projected path of the motor vehicle based on a current or anticipated trajectory of the motor vehicle. Controller 10 may utilize such information to optimize the efficiency of the motor vehicle. For example, controller 10 may retrieve information from computing unit 20 and GPS system 30 and may calculate a projected path of the motor vehicle based on this information and information retrieved from diagnostic computer 130. Such a calculated projected path may indicate that a road on which the vehicle is moving will soon be on a downward slope; and accordingly controller 10 may control engine 100 to decrease a speed of the engine as the vehicle goes downhill taking advantage of the force of gravity to propel the vehicle and thereby consume less fuel. Further, controller 10 could retrieve traffic information from a server, such as computing unit 20 or GPS system 130, which may indicate that traffic is congested at a certain distance from a current location of the vehicle; and controller 10 may accordingly cause a reduction in a speed of the engine to allow the vehicle to coast (i.e. not accelerate such that the engine consumes less fuel) as the vehicle approaches the location of the traffic congestion. In another example, a braking distance and a force placed on a braking system may be optimized by controller 10 such that a battery of a hybrid vehicle receives a maximum possible amount of recharge energy from the braking system during a deceleration and stopping of a vehicle at a stop sign, traffic signal or a location of traffic congestion.

Further, controller 10 may be coupled (e.g., via a wireless network) to one or more sensors 40 for detecting one or more aspects of the ambient environment near the motor vehicle. Such sensors could include an accelerometer, altimeter, thermometer, weather sensor(s), and a radar system for sensing a location of other vehicles, for example. Data received from such sensors may be utilized by controller 10 to optimize the fuel efficiency of the motor vehicle. For example, controller 10 could control engine 100 to decrease speed when an ambient temperature is low enough such that ice may form. Such a decrease in speed of a vehicle in anticipation of potentially icy conditions may increase safety and also may provide for increased fuel efficiency. For example, vehicles on the road in front of a motor vehicle may have reduced their speed due to the potentially slippery surface due to the cold weather and a slower deceleration may conserve fuel in addition to increasing safety by decreasing a likelihood of collision due to an attempt at rapid braking in slippery conditions.

System 5 (e.g., controller 10) may use location data (e.g., topographic information) to calculate the optimal required energy to get a vehicle from one location to another taking into account potential obstacles (e.g., topography, weather, traffic signals, traffic conditions) along the way between one location and another. This calculation is used to adjust user inputs and physical components of the car in such as way as to optimize energy usage. As indicated above, such user inputs could include acceleration, speed and braking rate. Non-user-inputs or physical components of the vehicle which could be adjusted include a fuel injection rate, the number of pistons in use by an engine, an engine speed, on-off status of an engine, and a timing of switching between an electric drive and a gasoline drive in a hybrid gas-electric car. Other user inputs and non-user inputs may also be taken into account during such a calculation by controller 10 of system 5.

In operation system 5 (e.g., controller 10 thereof) may utilize the data (e.g., GPS data, topographical data, temperature data, moisture data, accelerometer data, and altimeter data) obtained from remote sources and/or sensors on or near the motor vehicle to identify obstacles, such as a hill or stop sign. System 5 (e.g., controller 10) may perform one or more calculations according to physical characteristics (e.g., a weight, air drag, friction coefficient of the tires, etc.) of the motor vehicle (or a generic model) to determine the most optimal operation of the vehicle to address the particular obstacle(s) or other ambient characteristic(s) (e.g., weather, topography). Such obstacles may be static (e.g., topography) or dynamic, such as a traffic signal or traffic congestion, and therefore may require the user to input information, such as if the signal is green, yellow or red. Such input may be via a touchscreen or other interface near the driver of the motor vehicle, or could be via a voice interface such that the driver may merely speak with the instructions received and interpreted by controller 10. Such dynamic information may also be received wirelessly if a traffic signal, for example, was to transmit its status over a wired and/or wireless network, such as a cellular network. Further, traffic congestion information may also be sent wirelessly from a GPS system, for example. In another example, a radar system could also be employed to dynamically adjust fuel optimization by system 5. For example, such a radar system could detect the presence of other vehicles in front of the motor vehicle and may accordingly reduce the speed of the motor vehicle (e.g., by reducing the speed of the engine) so as to minimize braking by the driver and fuel consumption by the engine. In a further example, controller 10 may retrieve information from diagnostic computer 130 and adjustments may be made to any of the various system components 11 (e.g., engine 100, braking system 110, accelerator system 120, along with the other systems) based on a comparison of the information from computer 130 with any of the other described data.

In another example, system 5 may operate by both user inputs and the adjustment of systems 11 of the motor vehicle (e.g., engine components) automatically by controller 10. Specifically, system 5 could include both active and passive components. For example, system 5 could act passively to instruct the driver (e.g., via a display screen in the passenger area of the motor vehicle) as to the optimal speed, acceleration or braking (i.e., providing hypermiling instructions) to get past a particular obstacle (e.g., a hill, valley, traffic signal, weather condition, traffic congestion, etc.) with visual or audio cues, but could also act actively to automatically adjust components of the car such as an electric or hydrogen drive, piston usage and/or other components that the driver would normally not control. Such a system could also act actively to optimize any settings to user inputs, such as modifying the rate of acceleration which occurs in response to the user depressing the accelerator.

Controller 10 may also control portions of engine 100 to optimize fuel efficiency based on the aforementioned calculations and the user's dynamic inputs (e.g., braking, acceleration, etc.). In one example relative to hybrid-electric vehicles, controller 10 could control when the switching between the gasoline engine and electric drive occurs. Location data (e.g., GPS and topographical information) could also be utilized in determining when to do such switching. In another example, controller 10 could control which pistons to use or turn off when coasting down a hill and when to do such adjustment. Also, an engine may be turned off at a traffic light by controller 10. Further, as described above, such traffic lights could send information wirelessly to be received by receiver or antenna 27 to indicate to controller 10 a distance from a particular traffic light. Such information relative to a traffic light (e.g. status of light such as green, red or yellow, and distance from the light) may be utilized to determine when to decrease a speed of an engine 100. Further, data relative to a traffic light may be used in conjunction with data from a radar system, configured to determine a distance from a vehicle in front of the motor vehicle in which controller 10 is located, such that controller 10 may optimize fuel efficiency.

In another example, controller 10 could control how many tires are contacting the road, e.g., a tire lifting system (not shown) could lift a tire off the road on a straight away portion of a road thus reducing friction. Further, a shape of the vehicle (e.g., the aerodynamic characteristics of the vehicle) could be controlled via actuators located on various mobile portions of the body (e.g., sheet metal) of a vehicle.

In a further example, system 5 could operate similarly to current cruise control settings which adjust speed and acceleration to keep a car at a predetermined speed. This system would employ a predetermined level of efficiency. Similar to such a cruise control system, a user may override the system if the optimal level of efficient driving is not desired by the user, e.g., if the system provides a speed which too slow for a user's taste.

Further, networking with other vehicles as to what configurations and inputs were used at a particular geographic location could continuously improve fuel optimization and allow experimentation with different settings of the engines components in real time. For example, a computing unit (not shown) may receive data from various motor vehicles utilizing system 5 and may send such data to other vehicles such that the settings for a particular geographic location may be modified based on the use of system 5 by other users at a particular location. The settings for system 5 to optimize energy efficiency at such locations may thus be updated wirelessly, for example, such that the next user using system 5 at the particular location may utilize such updated settings thereby taking advantage of the previous user's experience at the particular location. Such sharing of information could also be performed by directly connecting different systems 5 to each other via any kind of network or connection (e.g., a wired USB connection).

As described above, “eco-driving” refers to fuel efficient driving techniques that maximize energy expenditures. These techniques include accelerating and braking at proper rates, maximizing the amount of time a car coasts and maximizing braking to recharge a hybrid electric system. In reality, drivers do not or cannot follow these guidelines for two major reasons. The first is the dynamic environment in which automobiles are driven, i.e., the only way to precisely know when and where to employ these techniques is with the aid of particular location instruments and computing power. Secondly, many drivers are not aware of the proper techniques for optimizing fuel efficiency. System 5 utilizes predictive calculations based on location data (e.g., topographic data from computing unit 20 and GPS data from GPS system 30) to influence user inputs through passively alerting the driver as to the correct action with audio visual cues, or by actively adjusting the users inputs directly so that those inputs are aligned with fuel optimization calculations.

For example, driver actions that do not maximize fuel efficiency include: a driver coming to a highway off-ramp braking too fast, a driver accelerating more than necessary when getting on a highway; and a driver not going at an optimal speed. Controller 10 could control acceleration of an engine to minimize the necessity for braking by slowing or stopping an engine in advance of a location where it is desired to stop such that braking is minimized. Also, acceleration could be optimized at a particular rate to optimize fuel consumption when acceleration is desired, e.g., when accelerating on a highway on-ramp. Further, such control of an engine to maximize fuel efficiency could take into account ambient information (e.g., topographic or other location specific information) when controlling such acceleration or deceleration. This control based on ambient information allows controller 10 to make adjustments based on particular data rather than assumptions or predictions.

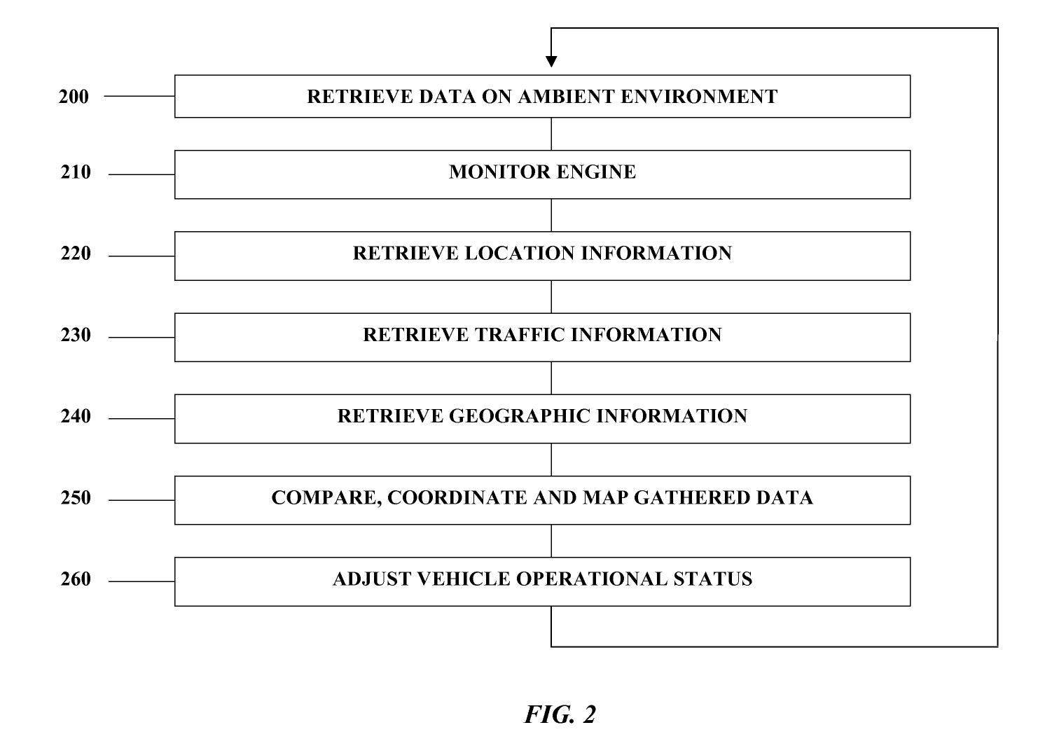

A method for optimizing fuel efficiency of a motor vehicle in accordance with the present invention is described as follows and is depicted in FIG. 2. Controller 10 retrieves information on an ambient environment nearby the motor vehicle via a variety of sensors, such as a thermometer, a radar sensing system, and a moisture sensor, for example (step 200). Controller 10 also retrieves information from diagnostic computer 130 of engine 100 of the motor vehicle to determine a current operational status (e.g., speed, accelerator setting, number of pistons in operation, engine speed, etc.) of the engine (step 210). Further, controller 10 retrieves location information from GPS system 300 via GPS antenna 25 (step 220). Controller 10 may also retrieve traffic condition information from GPS system 300 via GPS antenna 25 or from another source via a wireless network, such as a cellular network. Controller 10 may also retrieve other information (step 246), such as geographical information (e.g., including topographical information), weather condition information, traffic congestion information or other related information from various sources including computing unit 20, or other computing units coupled to controller 10 via an antenna 27 and a wireless network. Controller 10 may compare the various sources of information regarding current conditions of the current ambient environment of the motor vehicle and an ambient environment of the projected path of the motor vehicle to one another to coordinate such information to one another (step 250) and determine any anticipated obstacles to be overcome. The current operational status of the motor vehicle may then be adjusted (step 260) to take into account the information gathered and to optimize fuel efficiency based on the ecodriving principles described and is as known in the art. For example, the engine may be slowed in anticipation of a downward slope of a road because the force of gravity will aid movement of the motor vehicle down such a slope. The rate of acceleration may also be controlled to optimize fuel efficiency on a level or upward sloping trajectory. The operational status may be adjusted in any other of a number of ways based on the information gathered and to account for anticipated obstacles or conditions in the projected path of the vehicle. Suggested driving techniques may also be displayed to the driver visually or via spoken words in addition to, or instead of, direct control of control systems 11 of engine 100 by controller 10. The gathering of data or information and adjusting of the operational status of the engine described may be continuously and automatically performed by controller 10. All the indicated gathering of data or information may be done wirelessly or via a wired connection to the indicated sources. The process described may also be continuously repeated during operation of the motor vehicle.

The systems and methods described above could be utilized to optimize a fuel efficiency of various types of motor vehicles, such as cars, trucks, tractor-trailer trucks, trains or any other vehicles for which fuel efficiency is desired. Such vehicles may be powered by various fuels including gasoline, diesel fuel, biofuels, battery-power of various types, fuel cells, etc. Controller 10 and server 20 may be computing units having one or more central processing units, memory, one or more storage devices and one or more input/output devices, as is well known in the art. Further, controller 10 and/or additional computing units located in a motor vehicle may utilize information stored in one or more storage devices, such as topographic information tied to a particular location, configuration information to regulate the operation of systems 11 of the motor vehicle and/or other information which may be received via a wireless or wired connection and utilized at a later date. For example, topographic information and optimization information relative to a previous user's operation of a motor vehicle at a particular location may be stored in controller 10, or a storage device coupled thereto, for later use.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention.

1. A method for optimizing a fuel efficiency of a motor vehicle comprising:
electronically retrieving data on an ambient environment of a motor vehicle;
electronically comparing the data to a current operational status of the vehicle;
automatically adjusting the current operational status based on the comparing to optimize the fuel efficiency of the motor vehicle.

2. The method of claim 1 further comprising calculating a projected path of a motor vehicle and wherein the automatically adjusting the current operational status comprises automatically adjusting the current operational status based on the data and the projected path.

3. The method of claim 1 wherein the electronically retrieving the data comprises electronically retrieving geographical data and the adjusting comprises adjusting user inputs to the vehicle.

4. The method of claim 1 wherein the electronically retrieving the data comprises electronically retrieving geographical data and the adjusting comprises adjusting non-user controlled inputs to the vehicle.

5. The method of claim 1 wherein the electronically retrieving the data comprises electronically retrieving geographical positioning system coordinates and topographical information and the adjusting comprises adjusting a speed of the engine based on the data to optimize the fuel efficiency.

6. The method of claim 1 wherein the electronically retrieving the data comprises electronically retrieving data from a sensor configured to sense an aspect of the ambient environment.

7. The method of claim 1 wherein the electronically retrieving the data comprises electronically retrieving data regarding the weather of the ambient environment.

8. The method of claim 1 wherein the electronically retrieving the data comprises electronically retrieving data on an inclination of a road on which the motor vehicle is located.

9. The method of claim 1 further comprising electronically retrieving information from a diagnostic computer of the motor vehicle and wherein the automatically adjusting the current operation status comprises automatically adjusting the current operation status based on information from the diagnostic computer.

10. The method of claim 1 wherein the automatically adjusting comprises automatically adjusting a system of the motor vehicle to minimize an expenditure of fuel.

11. The method of claim 1 wherein the automatically adjusting comprises automatically adjusting an engine of the motor vehicle to minimize an expenditure of fuel.

12. A system for optimizing a fuel efficiency of a motor vehicle, the system comprising:
means for electronically retrieving data on an ambient environment of a motor vehicle;
means for electronically comparing the data to a current operational status of the vehicle; and
means for automatically adjusting the current operational status based on the comparing to optimize the fuel efficiency of the motor vehicle.

13. The system of claim 12 further comprising a sensor configured to sense an aspect of the ambient environment, said sensor coupled to said means for electronically retrieving data and configured to provide information to said means for electronically retrieving data regarding said aspect.

14. The system of claim 12 further comprising means for calculating a projected path of a motor vehicle and wherein said means for automatically adjusting the current operational status comprises means for automatically adjusting the current operational status based on the data and the projected path.

15. The system of claim 12 wherein said means for electronically retrieving data comprises means for electronically retrieving geographical data and said means for adjusting comprises means for adjusting inputs to control systems of the vehicle.

16. A method for optimizing a fuel efficiency of a motor vehicle comprising:
electronically retrieving data on an ambient environment and a projected path of a motor vehicle;
electronically comparing the data to a current operational status of the vehicle; and
outputting suggested adjustment criteria to a user based on the comparing to allow the user to provide input to control systems of the motor vehicle to optimize the fuel efficiency of the motor vehicle.

17. The method of claim 16 wherein the electronically retrieving the data comprises electronically retrieving geographical positioning system coordinates and topographical information and the adjusting comprises adjusting the engine based on the data to optimize the fuel efficiency.

18. The method of claim 16 wherein the electronically retrieving the data comprises electronically retrieving data from a sensor configured to sense an aspect of the ambient environment.

19. A system for optimizing a fuel efficiency of a motor vehicle, the system comprising:
a controller configured to electronically retrieve data on an ambient environment of a motor vehicle;
said controller configured to electronically compare the data to a current operational status of the vehicle; and
said controller configured to automatically adjust the current operational status based on the comparing to optimize the fuel efficiency of the motor vehicle.

20. At least one program storage device readable by a machine, tangibly embodying at least one program of instructions executable by the machine to perform a method for optimizing a fuel efficiency of a motor vehicle, the method comprising:
electronically retrieving data on an ambient environment of a motor vehicle;
electronically comparing the data to a current operational status of the vehicle; and
automatically adjusting the current operational status based on the comparing to optimize the fuel efficiency of the motor vehicle.
